(19) United States
(12) Patent Application Publication
(10) Pub. No.: US 2026/0276830 A1
(43) Pub. Date: Sep. 17, 2026

(54) FLEXIBLE ILLUMINATION PATTERN FOR A FLASH LIDAR SENSOR

(71) Applicant: Cepton Technologies, Inc., San Jose, CA (US)

(72) Inventors: Chang Seok Shin, Oakland, CA (US); Si Tan, Santa Clara, CA (US); Mark A. McCord, Los Gatos, CA (US)

(73) Assignee: Cepton Technologies, Inc., San Jose, CA (US)

(21) Appl. No.: 19/565,852

(22) Filed: Mar. 13, 2026

Related U.S. Application Data
(60) Provisional application No. 63/771,516, filed on Mar. 13, 2025.

(51) Int. Cl. G01S 17/894; G01S 7/481; G01S 7/4865

(52) U.S. Cl. CPC G01S 17/894; G01S 7/4816; G01S 7/4865

(57) ABSTRACT

Flash Lidar architectures can face challenges with dynamic range limitations, such as pixel saturation and blooming from highly reflective objects, and may benefit from enhanced spatial or temporal resolution for prioritized regions of interest. To address these challenges, a dynamic illumination approach is used to selectively target specific regions within a field of view. By dividing an array of photodetectors into multiple regions, initial image data is acquired and localized areas are identified and selected for re-illumination. These identified areas—such as regions containing saturated pixels or prioritized targets like vehicles—are then re-illuminated, without illuminating the entire field of view. An updated image frame is then generated or modified by integrating the baseline image data with data acquired from the targeted re-illumination, effectively improving dynamic range, resolution, and/or localized frame rates.

### CROSS-REFERENCES TO RELATED APPLICATIONS

This application claims the benefit of U.S. Provisional Patent Application No. 63/771,516, filed Mar. 13, 2025, which is incorporated by reference in its entirety for all purposes.

### BACKGROUND

Three-dimensional sensors can be applied in autonomous vehicles, drones, robotics, security applications, and the like. For example, Lidar projects an optical beam and detects light of the optical beam reflected by one or more objects in an environment. Lidar can be used to create a three-dimensional map of the environment, or portion thereof, based on detecting reflected light of the optical beam. Scanning Lidar sensors may achieve high angular resolutions appropriate for such applications at an affordable cost. An example of a scanning Lidar system is provided in U.S. Pat. No. 10,690,754, granted on Jun. 23, 2020, which is incorporated by reference for all purposes. However, improved scanning systems, apparatuses, and/or methods are desired.

A flash Lidar sensor is a type of camera that measures distance to objects across the field of view (FOV) as well as position in horizontal and vertical dimensions. Generally, they work by illuminating all or parts of the FOV with a short pulse of infrared light, and timing how long it takes the pulse to return to each pixel sensor of a receiver array.

### SUMMARY

In certain embodiments, a system for flash Lidar comprises a light source configured to emit light pulses to illuminate a field of view; a detector comprising an array of photodetectors configured to detect the light pulses reflected from one or more objects within the field of view, wherein the array of photodetectors is divided into a plurality of regions; and a memory device storing instructions that, when executed by one or more processors, cause the system to: illuminate, using light pulses from the light source reflected from the one or more objects, the plurality of regions to acquire image data; evaluate the image data to identify at least one specific region of the plurality of regions for re-illumination; re-illuminate the at least one specific region without re-illuminating all of the plurality of regions; and generate or modify an image frame so that the image frame includes at least a portion of the image data and data acquired from re-illuminating the at least one specific region.

In certain embodiments, a method for Lidar comprises illuminating a field of view using light pulses emitted from a light source; acquiring image data by detecting the light pulses reflected from one or more objects within the field of view using a detector, wherein the detector comprises an array of photodetectors divided into a plurality of regions; evaluating the image data to identify at least one specific region of the plurality of regions for re-illumination; re-illuminating the at least one specific region without re-illuminating all of the plurality of regions; and generating or modifying an image frame so that the image frame includes at least a portion of the image data and data acquired from re-illuminating the at least one specific region.

Systems and methods of the present disclosure can offer one or more technical advantages. For example, by evaluating the image data to identify at least one specific region for re-illumination, and re-illuminating only that region without re-illuminating the entire field of view, the system optimizes dynamic range locally. This targeted approach can reduce effects from blooming and/or saturation from highly reflective targets while maintaining sufficient illumination for the rest of the scene, and/or enable an increased effective frame rate or resolution for prioritized regions of interest without overburdening system power or processing resources.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 illustrates an embodiment of a Lidar sensor for three-dimensional imaging.

FIG. 2 depicts an embodiment of a system for flash Lidar.

FIG. 3 depicts an embodiment of a detector chip illustrating an example layout of pixels that are grouped into regions.

FIG. 4 depicts a flowchart of an embodiment of a process for reflashing at least one region of a detector array.

FIG. 5 illustrates a flowchart of an embodiment of a process for improving Lidar imaging within a region of interest (ROI).

FIG. 6 depicts a flowchart of an embodiment of a process for Lidar imaging.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

This disclosure relates generally, and without limitation, to Lidar systems for three-dimensional imaging and more specifically to flash Lidar systems. By way of example, some embodiments relate to flash with varying intensity.

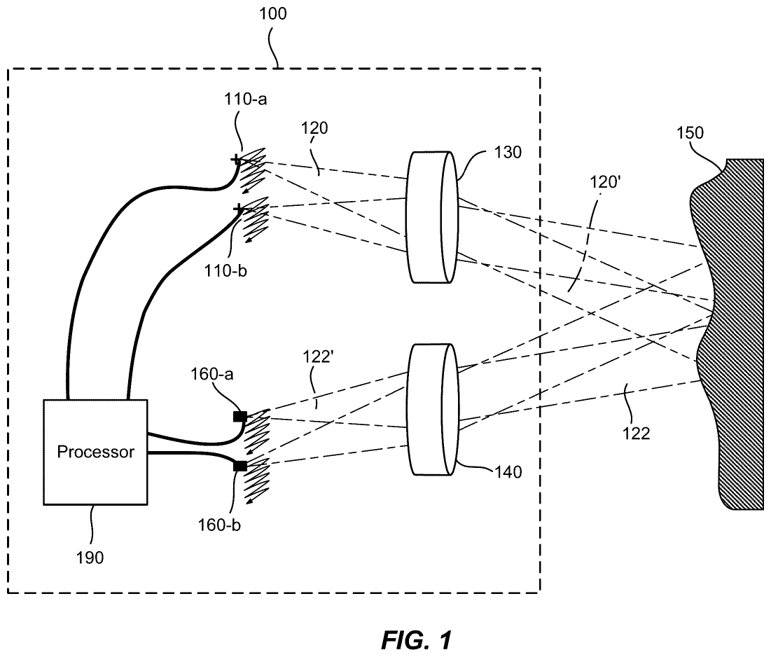

FIG. 1 illustrates an embodiment of a Lidar sensor 100 for three-dimensional imaging. The Lidar sensor 100 includes an emission lens 130 and a receiving lens 140. The Lidar sensor 100 includes a light source 110-a disposed substantially in a back focal plane of the emission lens 130. The light source 110-a is operative to emit a light pulse 120 from a respective emission location in the back focal plane of the emission lens 130. The emission lens 130 is configured to collimate and direct the light pulse 120 toward an object 150 located in front of the Lidar sensor 100. For a given emission location of the light source 110-a, the collimated light pulse 120′ is directed at a corresponding angle toward the object 150.

A portion 122 of the collimated light pulse 120′ is reflected off of the object 150 toward the receiving lens 140. The receiving lens 140 is configured to focus the portion 122′ of the light pulse reflected off of the object 150 onto a corresponding detection location in the focal plane of the receiving lens 140. The Lidar sensor 100 further includes a detector 160-a disposed substantially at the focal plane of the receiving lens 140. The detector 160-a is configured to receive and detect the portion 122′ of the light pulse 120 reflected off of the object at the corresponding detection location. The corresponding detection location of the detector 160-a is optically conjugate with the respective emission location of the light source 110-a.

The light pulse 120 may be of a short duration, for example, 10 ns pulse width. The Lidar sensor 100 further includes a processor 190 coupled to the light source 110-a and the detector 160-a. The processor 190 is configured to determine a time of flight (TOF) of the light pulse 120 from emission to detection. Since the light pulse 120 travels at the speed of light, a distance between the Lidar sensor 100 and the object 150 may be determined based on the determined time of flight.

One way of scanning a laser beam (e.g., light pulse 120′) across a FOV is to move the light source 110-a laterally relative to the emission lens 130 in the back focal plane of the emission lens 130. For example, the light source 110-a may be raster scanned to a plurality of emission locations in the back focal plane of the emission lens 130 as illustrated in FIG. 1. The light source 110-a may emit a plurality of light pulses at the plurality of emission locations. Each light pulse emitted at a respective emission location is collimated by the emission lens 130 and directed at a respective angle toward the object 150, and impinges at a corresponding point on the surface of the object 150. Thus, as the light source 110-a is raster scanned within a certain area in the back focal plane of the emission lens 130, a corresponding object area on the object 150 is scanned. The detector 160-a may be raster scanned to be positioned at a plurality of corresponding detection locations in the focal plane of the receiving lens 140, as illustrated in FIG. 1. The scanning of the detector 160-a is typically performed synchronously with the scanning of the light source 110-a, so that the detector 160-a and the light source 110-a are always optically conjugate with each other at any given time.

By determining the time of flight for each light pulse emitted at a respective emission location, the distance from the Lidar sensor 100 to each corresponding point on the surface of the object 150 may be determined. In some embodiments, the processor 190 is coupled with a position encoder that detects the position of the light source 110-a at each emission location. Based on the emission location, the angle of the collimated light pulse 120′ may be determined.

The X-Y coordinate of the corresponding point on the surface of the object 150 may be determined based on the angle and the distance to the Lidar sensor 100. Thus, a three-dimensional image of the object 150 may be constructed based on the measured distances from the Lidar sensor 100 to various points on the surface of the object 150. In some embodiments, the three-dimensional image may be represented as a point cloud, i.e., a set of X, Y, and Z coordinates of the points on the surface of the object 150.

In some embodiments, the intensity of the return light pulse 122′ is measured and used to adjust the power of subsequent light pulses from the same emission point, in order to prevent saturation of the detector, improve eye-safety, or reduce overall power consumption. The power of the light pulse may be varied by varying the duration of the light pulse, the voltage or current applied to the laser, or the charge stored in a capacitor used to power the laser. In the latter case, the charge stored in the capacitor may be varied by varying the charging time, charging voltage, or charging current to the capacitor. In some embodiments, the reflectivity, as determined by the intensity of the detected pulse, may also be used to add another dimension to the image. For example, the image may contain X, Y, and Z coordinates, as well as reflectivity (or brightness).

The angular field of view (AFOV) of the Lidar sensor 100 may be estimated based on the scanning range of the light source 110-a and the focal length of the emission lens 130 as,

$$AFOV = 2 {tan}^{- 1} ( \frac{h}{2 f} ) ,$$

where h is scan range of the light source 110-a along certain direction, and f is the focal length of the emission lens 130. For a given scan range h, shorter focal lengths would produce wider AFOVs. For a given focal length f, larger scan ranges would produce wider AFOVs. In some embodiments, the Lidar sensor 100 may include multiple light sources disposed as an array at the back focal plane of the emission lens 130, so that a larger total AFOV may be achieved while keeping the scan range of each individual light source relatively small. Accordingly, the Lidar sensor 100 may include multiple detectors disposed as an array at the focal plane of the receiving lens 140, each detector being conjugate with a respective light source. For example, the Lidar sensor 100 may include a second light source 110-b and a second detector 160-b, as illustrated in FIG. 1. In other embodiments, the Lidar sensor 100 may include four light sources and four detectors, or eight light sources and eight detectors. In one embodiment, the Lidar sensor 100 may include eight light sources arranged as a 4×2 array and eight detectors arranged as a 4×2 array, so that the Lidar sensor 100 may have a wider AFOV in the horizontal direction than its AFOV in the vertical direction. According to various embodiments, the total AFOV of the Lidar sensor 100 may range from about 5 degrees to about 15 degrees, or from about 15 degrees to about 45 degrees, or from about 45 degrees to about 120 degrees, depending on the focal length of the emission lens, the scan range of each light source, and the number of light sources.

The light source 110-a may be configured to emit light pulses in the near infrared wavelength ranges. The energy of each light pulse may be in the order of microjoules, which is normally considered to be eye-safe for repetition rates in the KHz range. For light sources operating in wavelengths greater than about 1500 nm (in the near infrared wavelength range), the energy levels could be higher as the eye does not focus at those wavelengths. The detector 160-a may comprise a silicon avalanche photodiode, a photomultiplier, a PIN diode, or other semiconductor sensors.

Additional Lidar sensors are described in commonly owned U.S. patent application Ser. No. 15/267,558 filed Sep. 15, 2016, Ser. No. 15/971,548 filed on May 4, 2018, Ser. No. 16/504,989 filed on Jul. 8, 2019, Ser. No. 16/775,166 filed on Jan. 28, 2020, Ser. No. 17/032,526 filed on Sep. 25, 2020, Ser. No. 17/133,355 filed on Dec. 23, 2020, Ser. No. 17/205,792 filed on Mar. 18, 2021, and Ser. No. 17/380,872 filed on Jul. 20, 2021, the disclosures of which are incorporated by reference for all purposes.

### I. Example Flash Lidar System

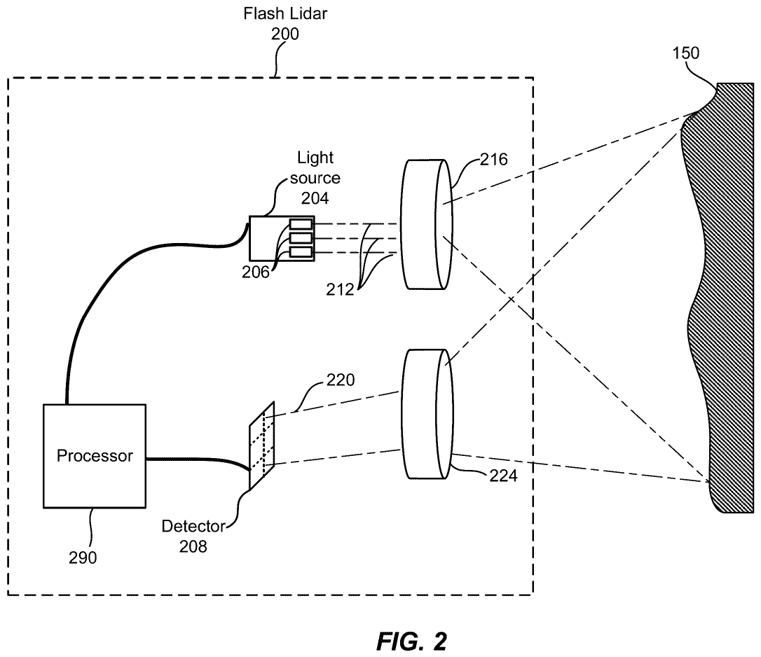

FIG. 2 depicts an embodiment of a system 200 for flash Lidar. FIG. 1 depicts an example for a scanning Lidar system. Flash Lidars generally operate by illuminating an entire scene, or field of view (FOV), simultaneously with a single, wide-angle pulse of laser light, functioning similarly to a traditional camera with a flash but utilizing the time-of-flight (ToF) principle. Unlike scanning Lidar, which uses moving parts to steer a beam across a field of view, a flash system generally employs a diffractive optical element (DOE) or a wide-angle lens to spread the laser pulse over the target area. The reflected photons are captured by a detector, such as a two-dimensional focal plane array (FPA) of highly sensitive photodetectors (e.g., Single-Photon Avalanche Diodes (SPADs) or Silicon Photomultipliers (SiPMs)). Each individual pixel in the array independently measures the time elapsed between the pulse emission and the detection of the backscattered signal. This allows the system to generate a 3D point cloud in a single “frame,” providing high temporal resolution and reducing or eliminating motion blur or spatial distortion (e.g., associated with mechanical scanning mechanisms).

To illuminate the entire FOV of the flash Lidar system 200 simultaneously can take kilowatts of instantaneous power. This can be difficult to supply electronically and may also cause disturbing electromagnetic pulses (EMP). Instead, in some embodiments, the flash Lidar system 200, breaks up the FOV into regions that are flashed sequentially. In some cases, each region may be a single column of pixels, or a few adjacent columns of pixels. In other implementations, a region may be a rectangular block of pixels that is a sub-multiple of the entire FOV, in horizontal and/or vertical dimensions.

The flash Lidar system 200 in FIG. 2 comprises a light source 204 and a detector 208. The light source 204 is arranged to emit pulses of light 212 (e.g. including a first pulse and a second pulse). A first lens 216 (e.g., a transmit lens) is used for spreading the pulses of light 212 within a field of view. Emitted pulses of light 212 are reflected by one or more objects 150 within the FOV. In some configurations, the light source 204 is a single emitter. In some configurations, the light source 204 comprises an array of emitters (e.g., solid state laser and/or LED), wherein each emitter of the array of emitters is individually addressable and/or can be individually controlled for power output. In some embodiments, the number of emitters corresponds to the number of regions. In some embodiments, the number of emitters is different than the number of regions. In some configurations, an emitter 206 is composed of multiple electro-optical components (e.g., one or more laser diodes and/or LEDs, lens(es), driver(s), etc.).

The detector 208 is arranged for detecting reflected light 220. Detecting reflected light 220 includes detecting light pulses emitted from the light source, after the light pulses are reflected from the one or more objects 150 within the field of view. The detector 208 comprises an array of photodetectors, and the array of photodetectors is divided into a plurality of regions. Reflected light 220 is focused to the detector using a second lens 224 (e.g., a receive lens). Though the transmit lens and the receive lens are shown as two separate lenses in FIG. 2, in some embodiments, the transmit lens and the receive lens are the same lens. In some configurations, multiple lenses are used for the transmit lens, the receive lens, or both. For example one lens could be used for each emitter, array emitters, group of emitters, photodetector, array of photodetectors, and/or group of photodetectors.

One or more memory devices comprising instructions that, when executed by one or more processors 290, optionally performs the following steps: generating an image frame based on the array of photodetectors detecting reflections from the first pulse; and revising the image frame based on photodetectors in one or more, but not all, regions detecting reflections from the second pulse. In some configurations, the processor 290 is part of a detector chip in the detector 208. A person skilled in the art will understand that processing functions can be integrated onto one chip or spread across processing chips.

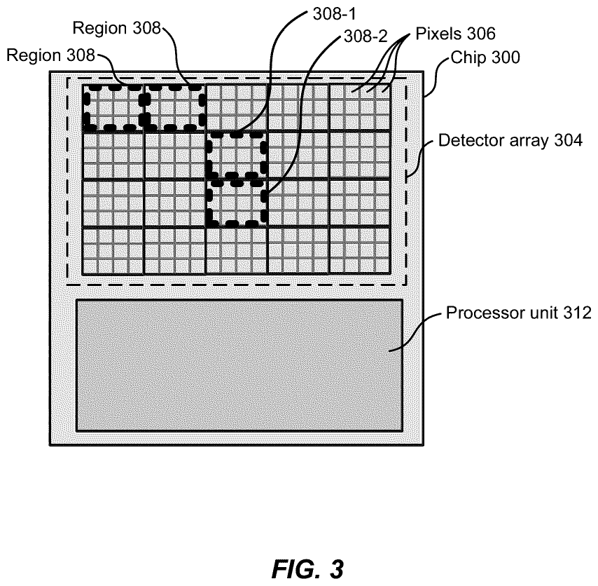

FIG. 3 depicts an embodiment of a chip 300 used in the detector 208 in FIG. 2. FIG. 3 depicts an example layout of pixels that are grouped into regions that in turn make up an array of photodetectors covering the FOV of the flash Lidar system.

The chip 300 (e.g., a silicon chip) for flash Lidar in FIG. 3 comprises a detector array 304 made of pixels 306 grouped into regions 308, as well as a processing unit 312 to process data from light detected by the detector array 304. In FIG. 3, a region 308 is 3 pixels tall by 4 pixels wide. This is shown just as an example. There can be more or fewer regions 308 than the example shown. Regions 308 can contain more or fewer pixels 306 than shown. FIG. 3 depicts a first region 308-1 and a second region 308-2, with additional regions not marked. The chip 300 can be referred to as a detector chip.

Retroreflective objects, such as street signs and license plates, can appear hundreds or even thousands of times brighter than dark, non-retroreflective objects. Flash Lidars can suffer from detector overload if a retroreflective object is in the FOV. Also, stray light from a retroreflective object can find its way into neighboring pixels due to non-ideal lens performance. Regardless, the result may be that reflected light from retroreflective object creates blooming on the chip (e.g., it appears larger in the image than its actual size), which can result in unintended consequences. For example, if reflected light from a stop sign blooms into the roadway, an autonomous vehicle may suffer an unwanted emergency stop to avoid hitting the phantom object.

To mitigate blooming, one technique is to reduce the laser illumination power when a retroreflective object appears in the FOV. In a flash Lidar, if a retroreflective object is detected in a first frame, then the laser power may be reduced in a subsequent frame. The reduction in subsequent frames typically affects the entire FOV, because traditional systems lack the capability to dynamically alter the scan pattern to target just one or a few regions without disrupting the frame cycle. The reduction may affect the entire FOV, or just one or a few regions. In either case, this approach can suffer from several problems. First, it is a reactive approach with some delay time (typically a frame which may be 1/10 to 1/30 of a second). Image information in the first frame may be compromised by the blooming. Information in the subsequent frame may be compromised because the lower laser power, while suitable for the retroreflector, may not be sufficient to illuminate non-retroreflective objects in the region or FOV. By changing the scan pattern from sequential to variable (e.g., random or pseudo-random) it is possible to mitigate one or more of these drawbacks.

In some Lidar systems, it can be desirable to acquire better information from certain regions of interest (ROI). In some cases, the ROI might be an identified object such as a vehicle or pedestrian. In other cases, it may be a specific part of the FOV, such as a center portion of the FOV, so as to get better information on the roadway straight ahead.

The additional information can be better resolution within the ROI, faster frame rate within the ROI, and/or more pixels from the ROI. By changing the scan pattern of regions from sequential to variable, it is possible to obtain additional information from the ROI by sampling one or more regions 308 from the ROI more frequently than regions 308 not within the ROI.

By allowing a variable scan of the regions 308 making up the FOV, it is possible to address one or more drawbacks discussed above. As an example, consider a flash Lidar configured to operate at 20 frames per second (50 msec per frame), and has 9×16 regions that can be flashed in a variable order. In addition, the Lidar sensor is constructed so that all regions can be flashed within 40 msec, leaving an additional 10 msec time window free for additional operations. For retroreflective objects, if a saturated region(s) is detected in the regular frame time of 40 msec, then that region(s) can be reflashed at a lower laser power during the 10 msec additional time window. The original saturated data, either the entire region or some subset thereof, can then be replaced with data taken at the lower power level to avoid saturation. By evaluating the image data to dynamically re-illuminate specific regions, the system can actively control and/or optimize the physical operation of the Lidar light source hardware, reducing instantaneous power draw and/or preventing physical saturation of the photodetector array.

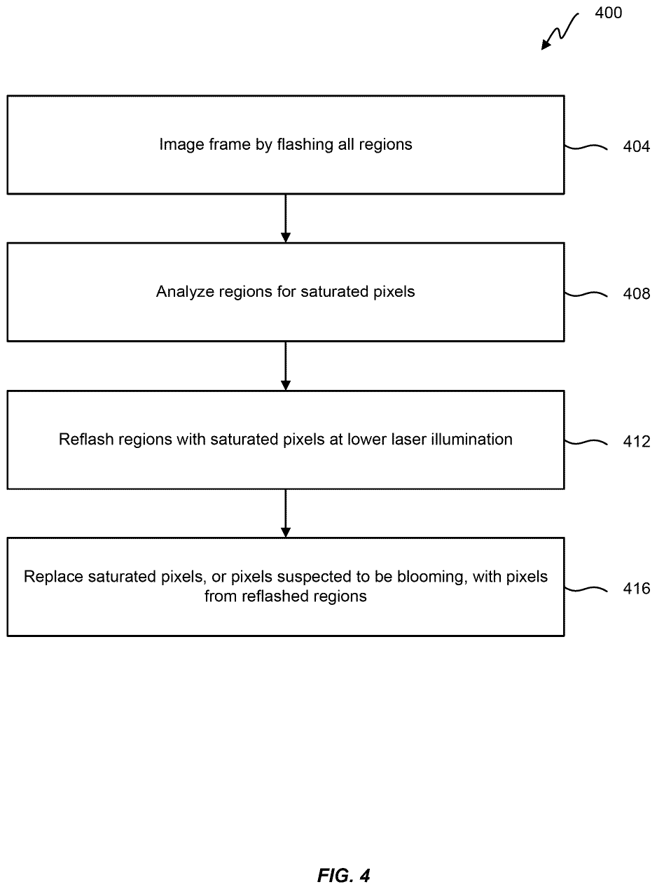

FIG. 4 depicts a flowchart of an embodiment of a process 400 for reflashing at least one region of a detector array. This can be used to improve Lidar imaging of very bright objects such as retroreflectors. The process 400 begins at step 404 by generating an image frame by flashing all regions within a field of view (FOV). In a flash Lidar system, the FOV may be broken up into a plurality of regions that are flashed to detect reflected light using an array of photodetectors.

At step 408, the regions for saturated pixels are analyzed. Highly reflective objects within the FOV, such as street signs or license plates, can reflect significantly more light than non-retroreflective objects, leading to detector overload. The system evaluates the image data to identify if specific regions contain saturated pixels caused by these bright reflections.

At step 412, the system reflashes the regions containing saturated pixels at a lower laser illumination. Rather than waiting for an entirely new frame or reducing the laser power for the entire FOV—which might leave non-retroreflective objects under-illuminated—the system targets the specific saturated regions. These regions can be reflashed at a reduced laser power during an additional time window to acquire usable, non-saturated data.

At step 416, the system replaces the saturated pixels, or pixels suspected to be blooming, with pixels from the reflashed regions. Stray light from a bright target can spill into neighboring pixels, causing the object to “bloom” or appear larger than its actual size on the chip. To resolve this, the original saturated data points, as well as points outside the object's boundary classified as blooming points, are replaced with the accurately resolved, non-saturated versions obtained from the lower-power reflash.

It is not necessary to wait for an entire frame to complete before reflashing saturated regions; they can be reflashed as soon as they are identified as saturated, interspersing the reflashed regions with the normally flashed regions of the entire frame

By comparing one or more saturated regions with the repeat non-saturated region(s), additional image processing operations may be enabled. For example, improved boundary detection of bright objects, such as retroreflective targets, is enabled. Classification of the object may be improved. For example, a hexagonal stop sign may be more accurately identified as such after its boundary is accurately detected (e.g., the boundary of an object may be identified by applying an edge-detection algorithm to the image data or determining an intensity gradient threshold between adjacent pixels). Saturated points within a boundary are then replaced with non-saturated versions. Saturated points outside the boundary can be classified as blooming points, and likewise replaced with non-saturated versions. Points outside the boundary, but at substantially the same distance from the Lidar sensor, may also be classified as blooming, and optionally removed from the image data set. Overall dynamic range of the image data may be improved as a region is flashed at lower and/or higher source power.

Similarly, if additional details for an ROI is desired, regions comprising the ROI can be flashed a second time during the 10 msec time window. Effectively the ROI would be operating at a 40 frames per second data rate, allowing for better object detection and tracking. For example, in one 50 msec frame, each region 308 in FIG. 3 is flashed once within a first 40 msec window and the first region 308-1 and the second region 308-2 are flashed a second time within a second 10 msec time window, without other regions 308 being flashed during the second time window. This allows for a higher effective frame rate in the first region 308-1 and the second region 308-2, which are in a center portion of the detector array 304 (e.g., for enhanced collision avoidance).

Image algorithms can be utilized to reduce noise or increase resolution in the ROI by making use of the extra pixel information.

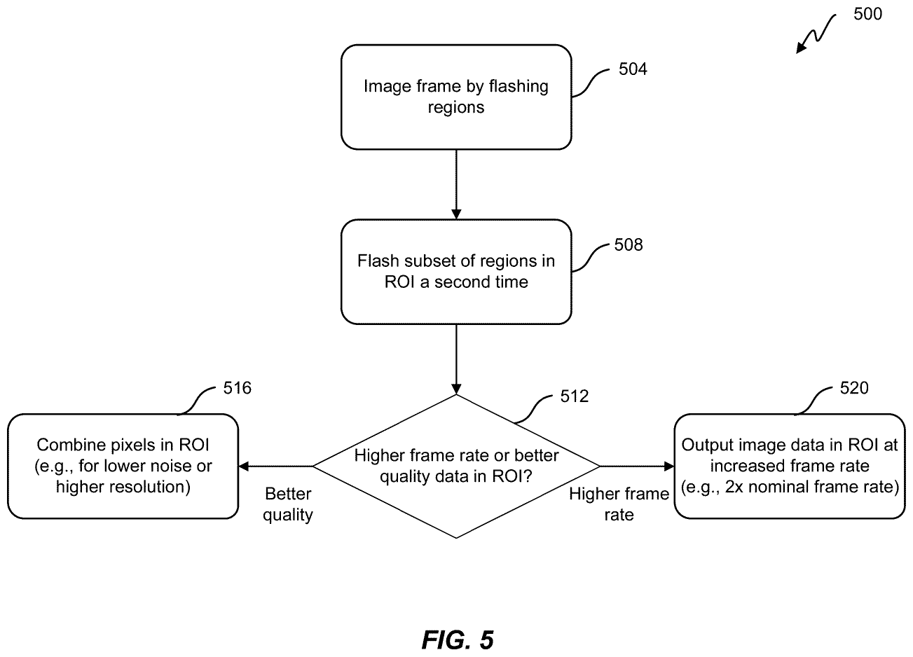

FIG. 5 illustrates a flowchart of an embodiment of a process 500 for improving Lidar imaging within a region of interest (ROI). The process enables a flash Lidar system to acquire better information from specific parts of the field of view (FOV) or from identified objects.

The process begins at step 504 by generating an image frame by flashing regions. Illuminating an entire FOV simultaneously can require kilowatts of instantaneous power, which can be difficult to supply electronically. To address this, the flash Lidar system breaks up the FOV into a plurality of regions that are flashed to generate the image frame. These regions make up an array of photodetectors covering the FOV of the flash Lidar system.

At step 508, the system flashes a subset of regions in an ROI a second time. In various applications, it is desirable to acquire better information from an ROI, which may encompass an identified object such as a vehicle or pedestrian, or a specific part of the FOV, such as a center portion for enhanced monitoring of a roadway. To acquire this additional information, the system can change the scan pattern of regions from sequential to variable to sample one or more regions from the ROI more frequently than regions not within the ROI. For example, regions comprising the ROI can be flashed a second time during an available time window.

The repeat flashing of the regions within the ROI at step 508 does not necessarily have to wait until the end of the frame. Instead, the secondary flashing of the ROI regions could be interspersed with the flashing of non-ROI regions in a pseudo-random order. In some cases, a first region is flashed two, three, or more times during one standard frame while a second region is flashed only one time. A standard frame is defined by a time period wherein each region is flashed at least one time and an image (e.g., a 3D image) is generated. Instructions to illuminate the plurality of regions and to re-illuminate the at least one specific region are executed prior to completing a standard frame (e.g., both are executed within a standard frame duration).

At step 512, the system determines whether to utilize the additional data for a higher frame rate or for better quality data in the ROI. By changing the scan pattern to allow variable scanning, the system can obtain additional information, such as better resolution, a faster frame rate, and/or more pixels from the ROI. The decision at step 512 routes the process based on the desired type of additional information.

If the system determines that better quality data is prioritized, the process proceeds to step 516 to combine pixels in the ROI. This combination can be used, for example, for lower noise or higher resolution within the ROI. Image algorithms can be utilized to reduce noise or increase resolution in the ROI by making use of the extra pixel information obtained from the repeated flashing.

If the system determines that a higher frame rate is prioritized, the process proceeds to step 520 to output image data in the ROI at an increased effective frame rate. For example, the output image data in the ROI could be at twice the standard (or nominal) frame rate (e.g., a 2× nominal frame rate). Effectively, by flashing the regions comprising the ROI a second time, the ROI operates at a higher data rate (e.g., 40 effective frames per second in the ROI rather than a standard 20 frames per second of the other regions), which allows for better object detection and tracking.

The above example is just an illustration of a possible implementation. The actual number of standard frames per second, image regions, and length of time windows can vary with the Lidar design and application.

In some configurations, a system comprises a light source arranged to emit pulses of light, including a first pulse and a second pulse; a lens for spreading the pulses of light within a field of view; a detector for detecting light pulses emitted from the light source, after the light pulses are reflected from one or more objects within the field of view, wherein the detector comprises an array of photodetectors, and the array of photodetectors is divided into a plurality of regions; and/or one or more memory devices comprising instructions that, when executed by one or more processors, performs the following steps: generating an image frame based on the array of photodetectors detecting reflections from the first pulse, and revising the image frame based on photodetectors in one or more, but not all, regions detecting reflections from the second pulse.

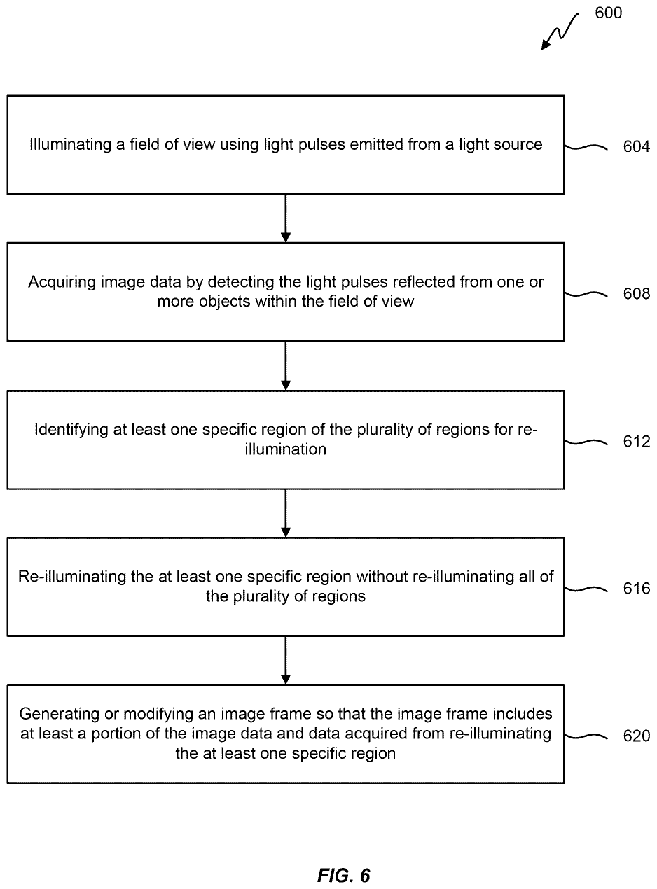

Referring next to FIG. 6, a flowchart of an embodiment of a process 600 for Lidar is shown. The process 600 may be used by a flash Lidar system to dynamically adapt illumination and/or efficiently update image data based on specific targets or regions within a field of view. The process 600 begins at step 604 by illuminating a field of view using light pulses emitted from a light source. In some embodiments, illuminating the field of view comprises illuminating a plurality of regions within the field of view during a first time window of a frame period.

At step 608, the system acquires image data by detecting light pulses reflected from one or more objects within the field of view using a detector. To facilitate targeted processing, the detector comprises an array of photodetectors divided into a plurality of regions.

At step 612, the system identifies at least one specific region of the plurality of regions for re-illumination. This evaluation can take different forms depending on the operational requirements or environmental conditions. For instance, identifying the at least one specific region for re-illumination can comprise detecting saturated pixels or blooming within the at least one specific region using the image data, which often occurs when scanning highly reflective objects. In some scenarios, identifying the at least one specific region of the plurality of regions for re-illumination comprises identifying that the at least one specific region corresponds to a region of interest. A region of interest can be static, such as one or more central regions. A region of interest can be dynamic, such as a region with an object of interest in the region, such as a person or vehicle. The system can include both static and dynamic regions of interest.

At step 616, the system re-illuminates the at least one specific region without re-illuminating all of the plurality of regions. In cases where saturation or blooming was detected, re-illuminating the at least one specific region can comprise emitting one or more light pulses at a lower power level than a power level used to acquire the initial image data. Furthermore, re-illuminating the at least one specific region can comprise re-illuminating the at least one specific region during a second time window of the frame period. The system can also operate in a variable scan pattern, where re-illuminating the at least one specific region comprises interspersing re-illuminating the at least one specific region with illuminating other regions of the plurality of regions.

At step 620, the system generates or modifies an image frame (e.g., based on generating a point cloud) so that the image frame (and the point cloud) includes at least a portion of the image data and data acquired from re-illuminating the at least one specific region. The image frame can be modified in several ways based on the data acquired. When dealing with highly reflective objects, generating or modifying the image frame can comprise replacing saturated data points from the initial image data with non-saturated data points obtained from re-illuminating the at least one specific region. The method can optionally comprise identifying a boundary of a retroreflective object within the at least one specific region, wherein generating or modifying the image frame comprises replacing data points outside the boundary that are classified as blooming points with data points from the re-illumination. When focusing on a region of interest, generating or modifying the image frame can optionally increase a resolution or an effective frame rate of the region of interest.

Various features described herein, e.g., methods, apparatus, computer-readable media and the like, can be realized using a combination of dedicated components, programmable processors, and/or other programmable devices. Some processes described herein can be implemented on the same processor or different processors. Where some components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may make reference to specific hardware and software components, those skilled in the art will appreciate that different combinations of hardware and/or software components may also be used and that particular operations described as being implemented in hardware might be implemented in software or vice versa.

Details are given in the above description to provide an understanding of the embodiments. However, it is understood that the embodiments may be practiced without some of the specific details. In some instances, well-known circuits, processes, algorithms, structures, and techniques are not shown in the figures.

While the principles of the disclosure have been described above in connection with specific apparatus and methods, it is to be understood that this description is made only by way of example and not as limitation on the scope of the disclosure. Embodiments were chosen and described in order to explain principles and practical applications to enable others skilled in the art to utilize the invention in various embodiments and with various modifications, as are suited to a particular use contemplated. It will be appreciated that the description is intended to cover modifications and equivalents.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary. Patents, patent applications, publications, and descriptions mentioned here are incorporated by reference in their entirety for all purposes. None is admitted to be prior art.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

Features discussed herein may be combined with other features. For example, the steps of detecting saturated pixels, emitting light at a lower power level, replacing saturated data points, identifying boundaries of objects, identifying regions of interest, and interspersing re-illumination within time windows can be utilized individually or in combination with the independent systems and methods described herein. The applicant reserves the right to claim any such combination of features.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to explain the principles of the invention and its practical applications to thereby enable others skilled in the art to utilize the invention in various embodiments and with various modifications as are suited to the particular use contemplated.

What is claimed is:

1. A system for flash Lidar comprising:
a light source configured to emit light pulses to illuminate a field of view;
a detector comprising an array of photodetectors configured to detect the light pulses reflected from one or more objects within the field of view, wherein the array of photodetectors is divided into a plurality of regions; and
a memory device storing instructions that, when executed by one or more processors, cause the system to:
illuminate, using light pulses from the light source reflected from the one or more objects, the plurality of regions to acquire image data;
identifying at least one specific region of the plurality of regions for re-illumination by detecting saturated pixels or blooming within the at least one specific region using the image data, and ascertaining that the at least one specific region corresponds to a region of interest containing a prioritized object including at least one of a pedestrian or a vehicle;
re-illuminate the at least one specific region without re-illuminating all of the plurality of regions by emitting one or more light pulses at a lower power level than a power level used to acquire the image data; and
generate or modify an image frame so that the image frame includes at least a portion of the image data and data acquired from re-illuminating the at least one specific region, wherein generating or modifying the image frame comprises replacing saturated data points from the image data with non-saturated data points obtained from re-illuminating the at least one specific region at the lower power level.

2. A system for flash Lidar comprising:
a light source configured to emit light pulses to illuminate a field of view;
a detector comprising an array of photodetectors configured to detect the light pulses reflected from one or more objects within the field of view, wherein the array of photodetectors is divided into a plurality of regions; and
a memory device storing instructions that, when executed by one or more processors, cause the system to:
illuminate, using light pulses from the light source reflected from the one or more objects, the plurality of regions to acquire image data;
identify at least one specific region of the plurality of regions for re-illumination;
re-illuminate the at least one specific region without re-illuminating all of the plurality of regions; and
generate or modify a point cloud so that the point cloud includes at least a portion of the image data and data acquired from re-illuminating the at least one specific region.

3. The system of claim 2, wherein the instructions to identify the at least one specific region comprise instructions to detect saturated pixels or blooming within the at least one specific region based on the image data.

4. The system of claim 3, wherein the instructions to re-illuminate the at least one specific region comprise instructions to emit one or more light pulses at a lower power level than a power level used to acquire the image data.

5. The system of claim 2, wherein the instructions to generate or modify the point cloud comprise instructions to replace saturated data points from the image data with non-saturated data points obtained from re-illuminating the at least one specific region.

6. The system of claim 2, wherein:
the memory device further stores instructions to identify a boundary of a retroreflective object within the at least one specific region; and
the instructions to generate or modify the point cloud comprise instructions to replace data points outside the boundary that are classified as blooming points with data points from re-illuminating the at least one specific region.

7. The system of claim 2, wherein evaluating the image data includes identifying the at least one specific region corresponds to a region of interest.

8. The system of claim 7, wherein the instructions to identify that the at least one specific region corresponds to the region of interest comprise instructions to ascertain that the at least one specific region contains a prioritized object including at least one of a pedestrian or a vehicle.

9. The system of claim 7, wherein generating or modifying the point cloud comprises combining pixels in the region of interest to increase a resolution, or outputting data for the region of interest at an increased effective frame rate.

10. The system of claim 2, wherein the instructions to re-illuminate the at least one specific region comprise instructions to intersperse re-illuminating the at least one specific region with illuminating other regions of the plurality of regions.

11. The system of claim 2, wherein:
the instructions to illuminate the plurality of regions includes instructions to illuminate the plurality of regions during a first time window of a frame period; and
the instructions to re-illuminate the at least one specific region comprise instructions to re-illuminate the at least one specific region during a second time window of the frame period.

12. A method for Lidar comprising:
illuminating a field of view using light pulses emitted from a light source;
acquiring image data by detecting the light pulses reflected from one or more objects within the field of view using a detector, wherein the detector comprises an array of photodetectors divided into a plurality of regions;
identifying at least one specific region of the plurality of regions for re-illumination;
re-illuminating the at least one specific region without re-illuminating all of the plurality of regions; and
generating or modifying a point cloud so that the point cloud includes at least a portion of the image data and data acquired from re-illuminating the at least one specific region.

13. The method of claim 12, wherein identifying the at least one specific region comprises detecting saturated pixels or blooming within the at least one specific region using the image data.

14. The method of claim 13, wherein re-illuminating the at least one specific region comprises emitting one or more light pulses at a lower power level than a power level used to acquire the image data.

15. The method of claim 12, wherein generating or modifying the point cloud comprises replacing saturated data points from the image data with non-saturated data points obtained from re-illuminating the at least one specific region.

16. The method of claim 12, further comprising identifying a boundary of a retroreflective object within the at least one specific region, wherein generating or modifying the point cloud comprises replacing data points outside the boundary that are classified as blooming points with data points from re-illuminating the at least one specific region.

17. The method of claim 12, wherein identifying the at least one region for re-illumination comprises identifying that the at least one specific region corresponds to a region of interest.

18. The method of claim 17, wherein generating or modifying the point cloud increases a resolution or an effective frame rate of the region of interest.

19. The method of claim 12, wherein re-illuminating the at least one specific region comprises interspersing re-illuminating the at least one specific region with illuminating other regions of the plurality of regions.

20. The method of claim 12, wherein:
illuminating the field of view comprises illuminating the plurality of regions during a first time window of a frame period; and
re-illuminating the at least one specific region comprises re-illuminating the at least one specific region during a second time window of the frame period.
